(19) United States
(12) Patent Application Publication
(10) Pub. No.: US 2018/0338469 A1
(43) Pub. Date: Nov. 29, 2018

(54) Pet Travel Bag

(71) Applicant: Cynthia Alexander, Palm Beach, FL (US)

(72) Inventor: Cynthia Alexander, Palm Beach, FL (US)

(21) Appl. No.: 15/991,718

(22) Filed: May 29, 2018

Related U.S. Application Data
(60) Provisional application No. 62/511,651, filed on May 26, 2017.

(51) Int. Cl. A01K 1/02

(52) U.S. Cl. CPC A01K 1/0254

(57) ABSTRACT

A pet travel bag is provided. The pet travel bag included a sidewall extending from a base forming an interior compartment, wherein the pet can rest on the base and within the interior compartment. A panel covers a pet passageway in the closed configuration and provides for access to the interior volume in an open configuration via the open pet passageway. The panel further includes a sub-panel that is independently reconfigurable between a working and non-working configuration. In the working configuration, the sub-panel is moved away from the panel to reveal a foot passageway. The foot passageway is positioned such that a user may insert his or her feet into the interior compartment, without requiring the opening of the panel. A covering extends over the foot passageway. In this way, the pet remains safe and secure within the housing.

### CROSS REFERENCE TO RELATED APPLICATION

This application claims the benefit of U.S. Provisional Application No. 62/511,651 filed on May 26, 2017. The above identified patent application is herein incorporated by reference in its entirety to provide continuity of disclosure.

### BACKGROUND OF THE INVENTION

### Field of the Invention

The present invention relates to a pet travel bag. More specifically, the present invention provides a pet travel bag having a housing adapted to receive and transport a pet therein.

Many pet owners travel with their pets (i.e. dogs and cats) on airplanes, trains, or vehicles if they are taking an extended trip. These trips can be traumatic for these pets, as the travel conditions can be uncomfortable, loud, and require long sedentary periods. Some pets require medication and the administration of drugs to maintain calmness throughout the journey.

Devices have been disclosed in the known art that relate to travel bags. These include devices that have been patented and published in patent application publications. These devices in the known art have several known drawbacks.

These devices however, fails to provide a pet travel bag movable panel having a sub-panel that provides limited access to the interior volume of the housing. There exists a need for a device that can provide the needed pet security and safety, while providing a manner of interacting and comforting the pet.

In light of the devices disclosed in the known art, it is submitted that the present invention substantially diverges in design elements from the devices in the known art and consequently it is clear that there is a need in the art for an improvement to existing bag devices. In this regard, the instant invention substantially fulfills these needs.

### SUMMARY OF THE INVENTION

In view of the foregoing disadvantages inherent in the known types of pet travel bags now present in the art, the present invention provides a new pet travel bag wherein the same can be utilized for providing convenience for the user when traveling with pets on airplanes, trains, or vehicles over long distances as a means of keeping pets calm during the journey. The pet travel bag included a sidewall extending from a base forming an interior compartment, wherein the pet can rest on the base and within the interior compartment. A panel disposed on a first end of the housing is selectively movable between a open and closed configuration. The panel covers a pet passageway in the closed configuration and provides for access to the interior volume in the open configuration via the open pet passageway. The panel further includes a sub-panel that is independently reconfigurable between a working and non-working configuration. In the working configuration, the sub-panel is moved away from the panel to reveal a foot passageway. The foot passageway is positioned such that a user may insert his or her feet into the interior compartment, without requiring the opening of the panel. A covering extends over the foot passageway, wherein the foot of the user and the pet within the housing are prevented from crossing the covering. In this way, the pet remains safe and secure within the housing, while the user can have limited access and interact with the pet.

It is therefore an object of the present invention to provide a new and improved pet travel bag having a housing for keeping pets therein, a panel for accessing an interior compartment at a first end, a sub-panel disposed on the panel, for accessing the interior compartment via a foot passageway when the panel is in a closed configuration.

It is another object of the present invention to provide a pet travel bag wherein the sub-panel includes a mesh cover that extend over the foot passageway.

Yet another object of the present invention is to provide a pet travel bag having a lip extending over the first end of the housing, the lip providing cover to the pet passageway and including a retractable handle extending therefrom.

Another object of the present invention is to provide a pet travel bag that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the pet travel bag in a closed configuration.

FIG. 2 shows a perspective view of the one embodiment of the pet travel bag in an open configuration.

FIG. 3 shows a perspective view of the one embodiment of the pet travel bag in a working configuration.

### DETAILED DESCRIPTION OF THE INVENTION

Reference is made herein to the attached drawings. Like reference numerals are used throughout the drawings to depict like or similar elements of the pet travel bag. For the purposes of presenting a brief and clear description of the present invention, the preferred embodiment will be discussed as used for pet travel bag. The figures are intended for representative purposes only and should not be considered to be limiting in any respect.

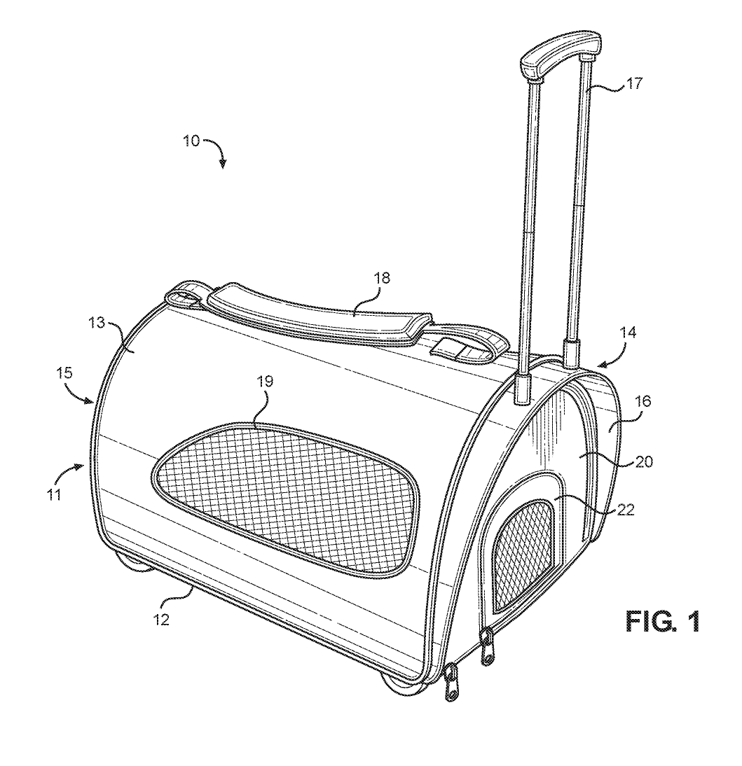

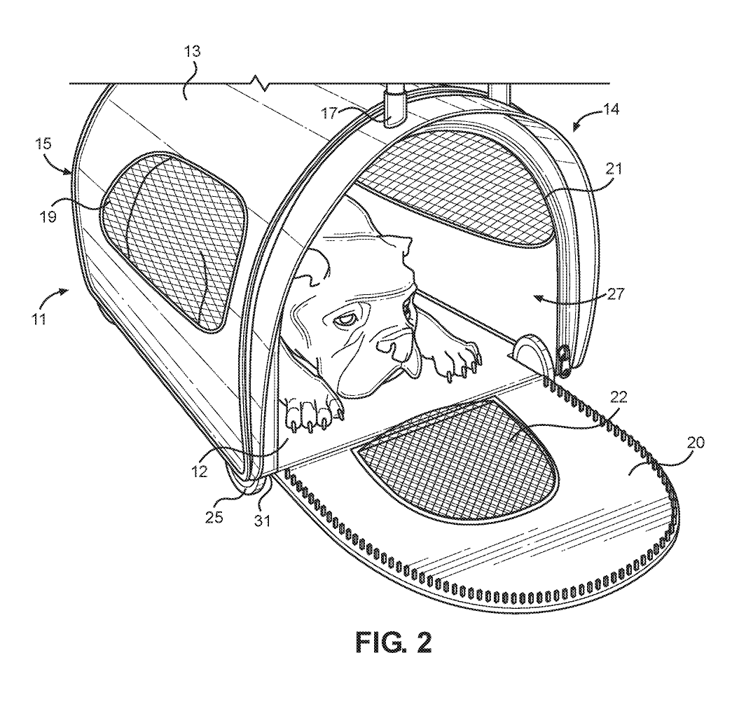

Referring to FIGS. 1 and 2, there is shown a perspective view of one embodiment of the pet travel bag in a closed configuration and there is shown a perspective view of one embodiment of the pet travel bag in an open configuration, respectively. The pet travel bag 10 provides a comfortable enclosure to pets of various sizes that is rollable long when traveling. The pet travel bag 10 comprises a housing 11 having a base 12 and a sidewall 13 that extends therefrom, forming an interior compartment 27 configured to receive a pet therein. The housing 11 includes a first end 14 and a second end 15, the second end 15 disposed on an opposing end of the housing 11. The first end 14 comprises a selectively openable panel for providing access to the interior compartment 27 via a pet passageway 21. In the shown embodiment, the sidewall 13 comprises an arched cross-section extending from lateral sides of the base to form a single curved roof and wall structure. In alternative embodiments, the sidewall 13 comprises a plurality of wall members in various configurations so as to form an open or closed enclosure for the pet.

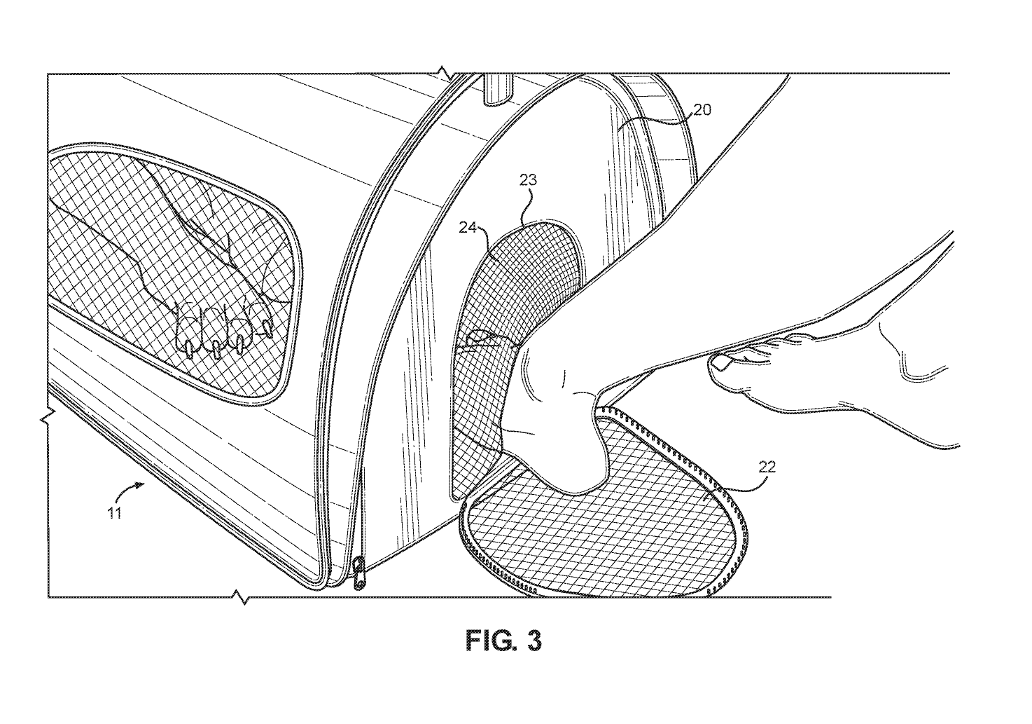

In the shown embodiment, the panel 20 is a planar member hingedly affixed to the housing 11 at a first end 14 and extending therefrom, so as to match the contours of the sidewall 13. The panel 20 is movable between an open configuration (as shown in FIG. 2) and a closed configuration (as shown in FIG. 3) via the hinge. In the open configuration, the panel 20 reveals a pet passageway 21 sized to accommodate a pet. In the closed configuration, the panel 20 forms coextensively with the sidewall 13 to define first end 14 of the interior compartment 27 the housing 13. In the shown embodiments, the pet passageway 21 is configured to be the entirely of the panel 20.

In the shown embodiment, the panel 20 comprises a sub-panel 22 for providing access to the interior compartment 27 via a foot passageway 23. In one embodiment, the sub-panel 22 is entirely disposed within a perimeter of the panel 20. The foot passageway 23 provides access to the interior compartment via the sub-panel being in a working configuration (as shown in FIG. 3).

In the shown embodiment, the pet travel bag 10 further comprising a lip 16 extending over a perimeter of the pet passageway 21, wherein the lip 16 extends at a greater distance from the first end 14 at a upper end 30, and tapers to a lesser distance at the lower end 31, wherein the base 12 is disposed towards the lower end 31. In one embodiment, the lip 16 forms an arched cross-section corresponding to the sidewall 13. In one embodiment, a handle 17 extends from the housing 11, the handle 17 being retractable and adapted to be handled so as to selectively move the pet travel bag 10. In one embodiment, the handle 17 extends from lip 16 at the first end 14. The handle 17 may be retractable via a telescoping mechanism that provides for a pair of parallel members to selectively extend and retract to and from the housing 17. In one embodiment, a strap 18 is disposed on the housing 11 and is configured to receive a body part therein, so as to support the pet travel bag 10. In the shown embodiment, the strap 18 is axially aligned with the housing 11, extending between the first end 14 and the second end 15.

In the one embodiment, the sidewall 13 comprises a window 19 thereon. In the shown embodiment, a pair of the windows 19 are disposed on opposing sides of the sidewall 13 and providing circulation of air to and from the interior compartment via a breathable material. In one embodiment, the windows 19 are non-openable so as to prevent any accidental opening to and escape of a housed pet. In one embodiment, a storage pouch disposed on the second end.

In FIG. 2, the panel 20 is hingedly affixed to the base 13 along a horizontal axis and outwardly rotatable to an open configuration, wherein an interior side of the panel 20 forms ramp towards the pet passageway 21. The panel 20 is rotatable more than ninety degrees so as to contact a ground surface to enable a pet to access the interior compartment 27 without forming a step. In the shown embodiment, the pet travel bag 10 includes a wheel assembly 25 disposed on the lower end 31 thereof. In one embodiment, the wheel assembly 25 is retractable, so as to provide a flat lower side that is adapted to rest flush with a horizontal ground surface. In this way, a pet disposed within the pet travel bag 10 is also resting on a flat surface. In one embodiment, the wheel assembly 25 includes a plurality of wheels disposed on the lower side, wherein each of the wheels extend out when handle 17 extended outward, and the wheel assembly 25 retract in when handle 17 retracts.

Referring to FIG. 3, there is shown a perspective view of one embodiment of the pet travel bag in a working closed configuration. In the working configuration, the sub-panel 22 of the pet travel bag 10 is positioned away from the panel 20 to provide access through the foot passageway 23. In the shown embodiment, the foot passageway 23 is entirely disposed within the perimeter of the panel 20, such that while the panel 20 remains in a closed configuration the sub-panel 22 is independently operably.

In the shown embodiment, the foot passageway 23 includes a covering 24 extending thereover. The covering 24 is configured to prevent a pet to pass through the foot passageway 23. In one embodiment, the covering 24 is adapted to be a breathable material that forms a barrier between the internal compartment 27 (as shown in FIG. 2) and an area exterior the housing 11. In one embodiment, the covering 24 is affixed to the panel 20 such that when the sub-panel 22 is in the working configuration the foot passageway 23 is entirely covered. In an alternative embodiment, the covering 24 is partially affixed around the foot passageway 23 to provide limited access to the interior compartment 27. In one embodiment, the covering 24 comprises excess material such that a portion of the covering 24 extend into the housing 11.

In one exemplary use, the pet is secured within the interior compartment 27 of the housing 11, which is in turn positioned underneath a forward seat in on a plane. The panel 20 is moved into the closed configuration, wherein the sub-panel 22 remains flush with the panel 20 along the exterior surface thereof. At some instance during the trip, the pet owner selectively reconfigures the sub-panel 22 into the working configuration. The user can comfort the pet by inserting the user's feet through the foot passageway 23 abutting the covering 24. Additionally, food or medications can be administered to the pet without removing the pet from the confines of the pet travel bag. The closeness and touch of the owner can provide anxiety relief to all parties.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet travel bag, comprising:
a housing having a sidewall extending from a base forming an interior compartment, the interior compartment configured to receive a pet therein;
the housing having a first end and a second end, wherein the first end comprises a selectively openable panel for providing access to the interior compartment via a pet passageway;
wherein the panel comprises a sub-panel, the sub-panel configurable into a working configuration, the working configuration adapted to providing access to the interior compartment via a foot passageway;
wherein the foot passageway includes a covering extending thereover, wherein the covering forms a barrier between the interior compartment and an exterior of the housing.

2) The pet travel bag of claim 1, wherein the panel is planar.

3) The pet travel bag of claim 1, wherein the panel and sub-panel are rotatable about a same horizontal axis.

4) The pet travel bag of claim 1, wherein the sidewall forms an arched cross-section between the first end and the second end.

5) The pet travel bag of claim 1, wherein the foot passageway is entirely enclosed by the panel.

6) The pet travel bag of claim 1, wherein the sub-panel is independently actuatable from the panel.

7) The pet travel bag of claim 1, further comprising a storage pouch disposed on the second end.

8) The pet travel bag of claim 1, wherein the panel is hingedly affixed to the base along a horizontal axis and outwardly rotatable to an open configuration, wherein an interior side of the panel forms ramp towards the pet passageway.

9) The pet travel bag of claim 1, wherein the sub-panel is hingedly affixed to the panel along a horizontal axis and outwardly rotatable to the working configuration.

10) The pet travel bag of claim 1, further comprising a lip extending over a perimeter of the pet passageway.

11) The pet travel bag of claim 10, wherein the lip extends at a greater distance from the first end at a upper end, and tapers to a lesser distance at the lower end, wherein the base is disposed towards the lower end.

12) The pet travel bag of claim 10, wherein the lip forms an arched cross-section corresponding to the sidewall.

13) The pet travel bag of claim 10, wherein a handle extends from the lip.

14) The pet travel bag of claim 13, wherein the handle extends from the housing, wherein the handle is retractable.

15) The pet travel bag of claim 1, wherein the sidewall comprises a window thereon, the window providing circulation of air to and from the interior compartment.

16) The pet travel bag of claim 1, wherein the housing comprises a strap configured for carrying thereof.

17) The pet travel bag of claim 1, wherein the housing comprises a wheel assembly disposed on an underside thereof, the wheels configured for rolling thereof.

18) The pet travel bag of claim 15, wherein the wheel assembly includes a plurality of wheels, wherein each of the wheels extend out when handle extended outward, and each wheel retracts when the handle retracts.
